(19) United States
(12) Patent Application Publication
(10) Pub. No.: US 2007/0116005 A1
(43) Pub. Date: May 24, 2007

(54) Apparatus to output multimedia data and method of outputting the same

(75) Inventor: Jung-hwan Oh, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/580,921

(22) Filed: Oct. 16, 2006

(30) Foreign Application Priority Data
Nov. 3, 2005 (KR) 2005-105002

(51) Int. Cl. H04L 12/56; H04L 12/28

(52) U.S. Cl. 370/395.2

(57) ABSTRACT

An apparatus to output multimedia data and a method of outputting the same, more particularly, an apparatus to output multimedia data and a method of outputting the same, in which multimedia data of all applicable formats is converted into multimedia data formats supported by a media center extender so as to be outputted, the apparatus to output multimedia data including a data processing unit receiving video data and audio data, a control unit converting process paths of the video data and the audio data, an encoding unit encoding the video data and the audio data transmitted according to the converted process paths into a predetermined compression format, and a communication unit transmitting the multimedia data according to the encoded result.

### CROSS-REFERENCE TO RELATED APPLICATIONS

This application claims from the benefit of Korean Patent Application No. 2005-105002 filed on Nov. 3, 2005, in the Korean Intellectual Property Office, the disclosure of which is incorporated herein by reference.

### BACKGROUND OF THE INVENTION

1. Field of the Invention

Aspects of the present invention relate to an apparatus to output multimedia data and a method of outputting the same, and more particularly, to an apparatus to output multimedia data and a method of outputting the same, in which multimedia data of all applicable formats is converted into multimedia data formats supported by a media center extender so as to be outputted.

2. Description of the Related Art

A media center extender (hereinafter, referred to as an MCX) receives multimedia data from a computer through wire communication and wireless communication, and displays the multimedia data through a display unit, such as a TV. Generally, the MCX is provided near the TV, and converts the multimedia data received from the computer into an analog signal and transmits it to the TV. In this way, the multimedia data is displayed through the TV.

FIG. 1 is a diagram illustrating a conventional MCX system including a TV 10, an MCX 20, and a computer 30.

The TV 10 displays the multimedia signal transmitted by the MCX 20. In this case, the multimedia signal transmitted by the MCX 20 may be a composite signal, a component signal or an S-Video signal.

The MCX 20 converts the multimedia data transmitted by the computer 30 into the composite signal, the component signal or the S-Video signal, and transmits the signal to the TV 10. In order to perform this function, the MCX 20 includes a communication unit that can communicate with the computer 30, such as an LAN or a wireless LAN.

The MCX 20 receives a user's instruction inputted through an input unit, such as a remote controller, and requests multimedia data according to the user's instruction, from the computer 30.

The computer 30 stores the multimedia data, and transmits the multimedia data according to the request of the MCX 20. Accordingly, the computer 30 may also include a communication unit, such as an LAN or a wireless LAN, as in the MCX 20.

A plurality of TVs 10 and a plurality of MCXs 20 can process multimedia data transmitted by one computer 30. Similarly, a plurality of TVs 10 can display the data.

Meanwhile, a format of the multimedia data that the MCX 20 can receive from the computer 30 so as to convert the multimedia data into an analog signal is restricted. That is, the MCX 20 may only be able to convert data having formats of Motion Picture Experts Group (MPEG) and Window Media Video (WMV).

Accordingly, the multimedia data of the MPEG format or the WMV format is transmitted to the MCX 20 while being displayed through a monitor 40 of the computer 30, and the multimedia data can be displayed through the TV 10. In contrast, since multimedia data having formats other than the MPEG or WMV format cannot be converted into that analog signal by the MCX 20, such multimedia data cannot be displayed through the TV 10.

Korean Laid-Open Publication No. 2003-6107 discloses an apparatus to display Internet data on a television screen that includes: a signal conversion and output unit to convert digital A/V signals of a computer, provided through the Internet, into TV signals for wireless transmission, and transmits the TV signals; and a receiver to divide the TV signals into video signals and audio signals to output them.

However, there is a problem in that the computer is exclusively interlocked with the TV. Specifically, since an individual computer needs to be provided to transmit the digital A/V signal to each TV, a plurality of computers are required to display multimedia contents through a plurality of TVs spaced apart from one another.

Therefore, various methods have been required for multimedia data having various data formats stored in the computer to be processed through the conventional MCX.

### SUMMARY OF THE INVENTION

Aspects of the present invention provide an apparatus to output multimedia data and a method of outputting the same, in which multimedia data of all formats is converted into multimedia data formats supported by a media center extender so as to be outputted.

According to an aspect of the present invention, there is provided an apparatus to output multimedia data, the apparatus including a data processing unit receiving video data and audio data, a control unit converting process paths of the video data and the audio data, an encoding unit encoding the video data and the audio data transmitted according to the converted process paths into a predetermined compression format, and a communication unit transmitting the multimedia data according to the encoded result.

According to another aspect of the present invention, there is provided a method of outputting multimedia data, the method including receiving video data and audio data, converting process paths of the video data and the audio data, encoding the video data and the audio data transmitted according to the converted process paths into a predetermined compression format, and transmitting the multimedia data according to the encoded result.

Additional aspects and/or advantages of the invention will be set forth in part in the description which follows and, in part, will be obvious from the description, or may be learned by practice of the invention.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram illustrating a conventional MCX system;

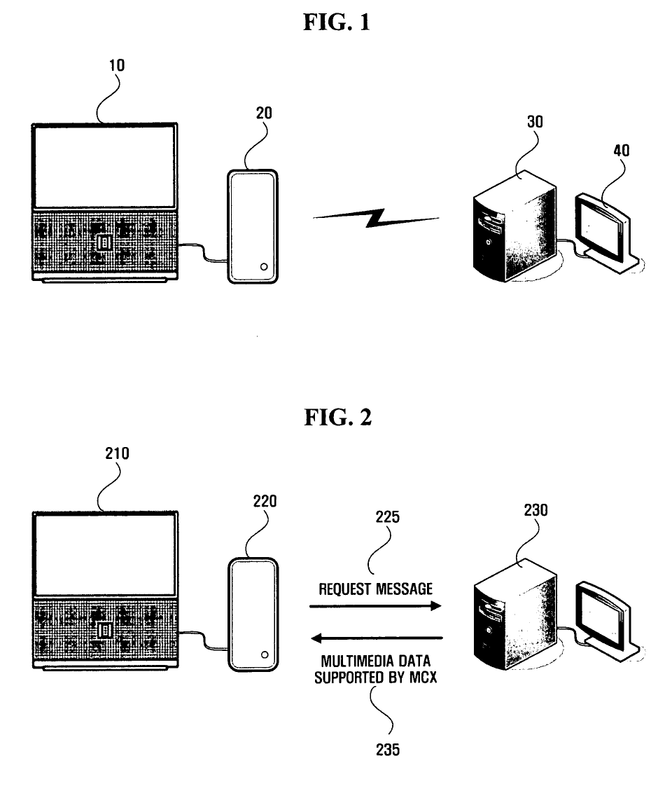

FIG. 2 is a diagram illustrating an MCX system according to an embodiment of the present invention;

FIG. 3 is a block diagram illustrating an apparatus to output multimedia data according to an embodiment of the present invention;

FIGS. 4A and 4B are diagrams illustrating a path processing multimedia data according to an embodiment of the present invention; and

FIG. 5 is a diagram illustrating a process to output multimedia data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

It is understood that blocks in the accompanying block diagrams and compositions of operations in flow charts can be performed by computer program instructions. These computer program instructions can be provided to processors of, for example, general-purpose computers, special-purpose computers, and programmable data processing apparatuses, although not limited thereto. Therefore, the instructions performed by, for example, the computer or the processors of the programmable data processing apparatus execute functions described in the blocks in the block diagrams or the operations in the flow charts. The computer program instructions can be stored in a computer available memory or a computer readable memory of the computer or the programmable data processing apparatus in order to realize the functions in a specific manner. However, it is understood that the instructions may be stored in any computer-readable storage medium. Therefore, the instructions stored in, for example, the computer-available memory or the computer-readable memory can perform the functions described in the blocks in the block diagrams or the operations in the flow charts. Also, the computer program instructions can, for example, be loaded onto the computer or the programmable data processing apparatus. Therefore, a series of operations is performed in the computer or the programmable data processing apparatus to generate a process executed by the computer, which makes it possible for instructions driving the computer or the programmable data processing apparatus to provide operations to execute the functions described in the blocks of the block diagrams or the operations of the flow charts.

Each block or each operation may indicate a portion of a module, a segment, or a code including one or more executable instructions to perform a specific logical function (or functions). It should be noted that, in some modifications of the present invention, the functions described in the blocks or the operations may be executed out of order. For example, two blocks or operations continuously shown can actually be performed at the same time, or they can be performed in reverse order according to the corresponding functions.

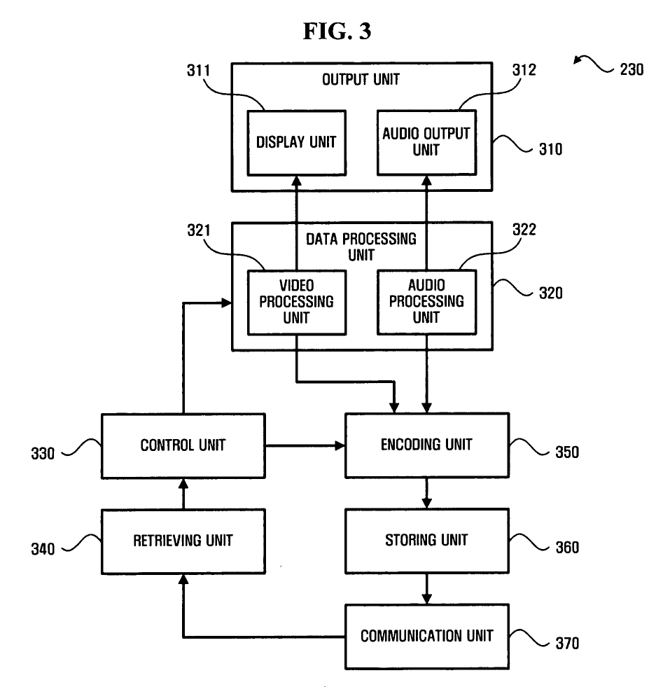

FIG. 2 is a diagram illustrating an MCX system according to an embodiment of the present invention. This MCX system includes a TV 210, an MCX 220, and an apparatus to output multimedia data 230 (hereinafter, referred to as a multimedia data output apparatus 230).

The multimedia data output apparatus 230 stores multimedia data, and transmits the stored multimedia data in accordance with a request message 225 of the MCX 220. Further, when the multimedia data according to the request message 225 of the MCX 220 is not multimedia data of a format supported by the MCX 220, the multimedia data output apparatus 230 converts the corresponding multimedia data into multimedia data 235 of a format supported by the MCX 220, and transmits the converted multimedia data 235 to the MCX 220. That is, the multimedia data output apparatus 230 converts the corresponding multimedia data into a Motion Picture Experts Group (MPEG) format or a Windows Media Video (WMV) format. However, it is understood that the MPEG and WMV formats are not the only formats that the multimedia data output apparatus 230 converts the multimedia data into. The multimedia data output apparatus 230 performs data conversions according to formats supported by the MCX 220.

According to a method of converting data, after the stored multimedia data is reproduced, the reproduced video and audio signals are transmitted to a TV output port 410, and the signals transmitted to the TV output port 410 are encoded into the above-mentioned compression format.

The encoded multimedia data is transmitted to the MCX 220 through a communication unit.

The MCX 220 converts the multimedia data transmitted by the multimedia data output apparatus 230 into a composite, component, or S-Video signal, and then transmits the converted signal to the TV 210. However, it is understood that the multimedia signal may be of any type or form capable of transmitting multimedia data to a TV 210.

A user can retrieve the multimedia data stored in the multimedia data output apparatus 230 through a remote controller, although not limited thereto. The multimedia data, which has been retrieved through, for example, the remote controller and selected by the user, is converted into data of a proper format by the multimedia data output apparatus 230, and then transmitted to the MCX 220.

The TV 210 outputs the multimedia signal received from the MCX 220 on a screen. In this case, since the received multimedia signal may be an analog signal or digital data, the TV 210 may be an analog TV or a digital TV. Further, the MCX 220 converts the multimedia data into the analog signal or the digital data according to a process capability of the TV 210, and transmits the multimedia signal.

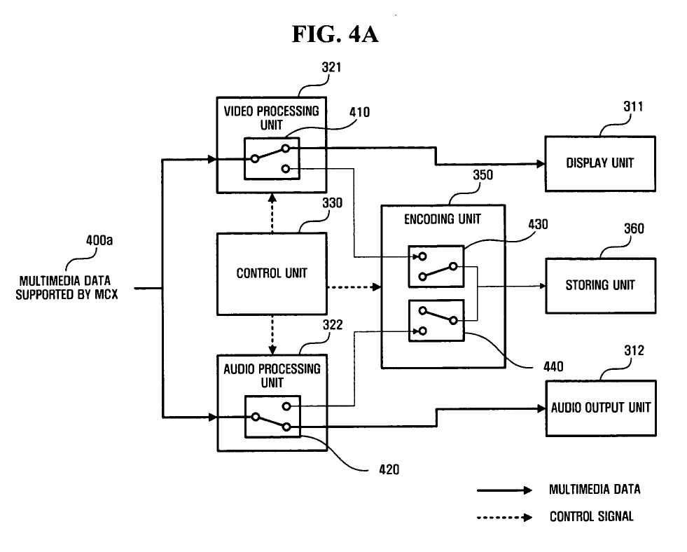

FIG. 3 is a block diagram illustrating a multimedia data output apparatus according to an embodiment of the present invention. The multimedia data output apparatus 230 includes an output unit 310, a data processing unit 320, a control unit 330, a retrieving unit 340, an encoding unit 350, a storing unit 360, and a communication unit 370, although not limited thereto.

The data processing unit 320 receives video data and audio data. Specifically, the data processing unit 320 includes a video processing unit 321 that receives the video data, and an audio processing unit 322 that receives the audio data.

The video processing unit 321 converts the video data into signals that are used to reproduce characters or graphic patterns (bitmaps) in a memory on a screen. The video processing unit 321 may have a memory incorporated therein, and the memory may be used to create videos before the characters or graphic patterns are displayed on the screen.

The audio processing unit 321 receives the audio data of a digital format, and converts the audio data of the digital format into an audio signal of an analog format.

The video data and the audio data, which are inputted to the video processing unit 321 and the audio processing unit 322, may, although not necessarily, be multimedia data stored in the storing unit 360 or may, although not necessarily, be TV signals inputted through a TV receiving unit (not shown) provided in the multimedia data output apparatus 230. In this case, the video signal of the TV signal may be converted into a digital signal and then inputted to the video processing unit 321.

The output unit 310 includes a display unit 311 and an audio output unit 312. The display unit 311 corresponds to a module that includes a video display device, such as, although not limited to, a cathode ray tube (CRT), a liquid crystal display (LCD), a light-emitting diode (LED), an organic light-emitting diode (OLED), or a plasma display (PDP), which is capable of displaying inputted video data. The display unit 311 displays the transmitted video information.

The audio output unit 312 outputs the analog audio signal transmitted by the audio processing unit 322. That is, the audio output unit 312 corresponds to an audio output device, such as a speaker.

The retrieving unit 340 retrieves multimedia data contained in the request message 225 received from the MCX 220. That is, the retrieving unit 340 retrieves the multimedia data by, for example, using a file name and a storage path of the multimedia data contained in the request message, and transmits the retrieved multimedia data to the control unit 330. In this case, the retrieved result may contain a header or metadata of the multimedia data.

The control unit 330 converts process paths of the video data and the audio data. That is, the video data and the audio data that have been processed by the data processing unit 320 are not necessarily transmitted to only the output unit 310, but may be transmitted to the encoding unit 350.

A multimedia data process path determined by the control unit 330 may be determined according to an instruction of the user. Further, the multimedia data process path may be determined by only the output unit 310 or the encoding unit 350. Moreover, the multimedia data process path may be determined such that the multimedia data is simultaneously transmitted to the output unit 310 and the encoding unit 350.

The multimedia data process path determined by the control unit 330 may be determined according to the retrieved results transmitted by the retrieving unit 340. That is, in a case in which the format of the requested multimedia data corresponds to a format supported by the MCX 220, the control unit 330 converts the process path to lead to the output unit 310, and in a case in which the format of the requested multimedia data does not correspond to a format supported by the MCX 220, the control unit 330 may convert the process path to lead to the encoding unit 350.

In a case in which the process path of the multimedia data leads to the encoding unit 350, the video processing unit 321 and the audio processing unit 322 output the video data and the audio data through a TV out port 410 and a line out port 420, respectively. In this case, each of the TV out port 410 and the line out port 420 includes a port exposed to the exterior and a port for inner connection. When the process path of the multimedia data leads to the encoding unit 350, the video data and the audio data are transmitted to the encoding unit 350 through the ports for inner connection. That is, the configuration is such that the video data and the audio data are not transmitted through the ports exposed to the exterior, which can be achieved by switches.

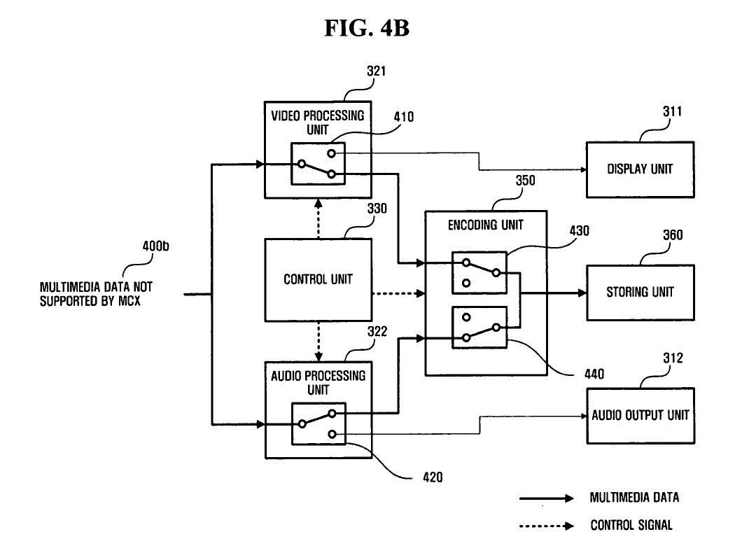

The detailed description for the multimedia data process path will be described below with reference to FIGS. 4A and 4B.

The encoding unit 350 encodes the video data and the audio data transmitted through the converted path of the multimedia data, converted by the control unit 330, in a predetermined compression format.

That is, the encoding unit 350 converts the multimedia data into a data format recognized by the MCX 220. In the present embodiment, the recognized conversion format may be an MPEG format or a WMV format. However, it is understood that the multimedia data can be encoded into a different moving picture compression format according to a data format supported by the MCX 220 in the future.

The storing unit 360 stores the multimedia data encoded by the encoding unit 350. That is, the storing unit 360 stores the multimedia data in a data format recognized by the MCX 220. The storing unit 360 serves as a buffer in order for the multimedia data to be transmitted through the communication unit 370.

The storing unit 360 corresponds to a module in which input and output of information can be made, such as, although not limited to, a hard disk, a flash memory, a compact flash (CF) card, a secure digital (SD) card, a smart media (SM) card, a multimedia card (MMC), or a memory stick. The storing unit 360 may be provided in the apparatus to output multimedia data or may be provided in a separate device.

The communication unit 370 transmits the multimedia data according to the encoded result. That is, the communication unit 370 transmits the multimedia data stored in the storing unit 360 or transmits the multimedia directly transmitted by the encoding unit 350 to the MCX 220.

Further, the communication unit 370 receives the request message 225 for multimedia data from the MCX 220. Then, the transmitted request message 225 is transmitted to the control unit 330 and used in determining the process path of the stored multimedia data.

Wire communication methods such as, although not limited to, Ethernet, Universal Serial Bus (USB), IEEE 1394, serial communication, and parallel communication may, although not necessarily, be used between the communication unit 370 and the MCX 220. In addition, wireless communication methods such as, although not limited to, Infrared Data Association, Bluetooth, home RF, and a wireless LAN may, although not necessarily, be used.

The multimedia data transmitted through the communication unit 370 is transmitted to the MCX 220. Then, the MCX 220 displays the multimedia data through the TV 210 because the multimedia data of the format supported by the MCX 220 is transmitted.

As described above, the video processing unit 321 includes a TV out port 410, and the audio processing unit 322 includes a line out port 420. The TV out port 410 converts the reproduced video contents into analog video signals and outputs the converted analog signals. The analog video signals outputted by the TV out port 410 may be displayed through the TV 210. Meanwhile, the line out port 420 converts the reproduced audio contents into analog audio signals and outputs the converted analog signals. The analog audio signals outputted by the line out port 420 may be outputted through the audio output unit 312, such as a speaker,

The encoding unit 350 includes a TV in port 430 and a line in port 440. Thus, the encoding unit 350 encodes the video signals and the audio signals inputted through the TV in port 430 and the line in port 440.

As shown in FIGS. 4A and 4B, each of the TV out port 410 of the video processing unit 321, the line out port 420 of the audio processing unit 322, and the TV in port 430 of the encoding unit 350 includes a switch such that the multimedia data is processed according to the multimedia data process path determined by the control unit 330.

FIG. 4A is a diagram illustrating a process path determined by the control unit 330 in a case in which the multimedia data 400a of a format supported by the MCX 220 is requested. The multimedia data having been inputted to the video processing unit 321 and the audio processing unit 322 corresponds to the multimedia data 400a of the format supported by the MCX 220. Thus, the control unit 330 transmits control instructions to the video processing unit 321, the audio processing unit 322, and the encoding unit 350, such that the video data is displayed through the display unit 311, and the audio data is outputted through the audio output unit 312.

That is, the multimedia data process path is determined such that the TV out port 410 of the video processing unit 321 is connected to the display unit 311, and the line out port 420 of the audio processing unit 322 is connected to the audio output unit 312.

FIG. 4B is a diagram illustrating a process path determined by the control unit 330 in a case in which the multimedia data 400b of a format not supported by the MCX 220 is requested. The multimedia data having been inputted to the video processing unit 321 and the audio processing unit 322 corresponds to the multimedia data 400b of the format that is not supported by the MCX 220. Thus, the control unit 330 transmits control instructions to the video processing unit 321, the audio processing unit 322, and the encoding unit 350, such that the video data and the audio data are inputted to the encoding unit 350.

That is, the multimedia data process path is determined such that the TV out port 410 of the video processing unit 321 is connected to the TV in port 430 of the encoding unit 350, and the line out port 420 of the audio processing unit 322 is connected to the line in port 440 of the encoding unit 350.

The video data and the audio data that are transmitted to the encoding unit 350 are encoded into multimedia data of a format that is supported by the MCX 220, and then may, although not necessarily, be transmitted to the storing unit 360 to be stored therein.

As described above, the multimedia data process path determined by the control unit 330 may be determined according to the user's instruction or may be determined according to the format of the multimedia data requested by the MCX 220.

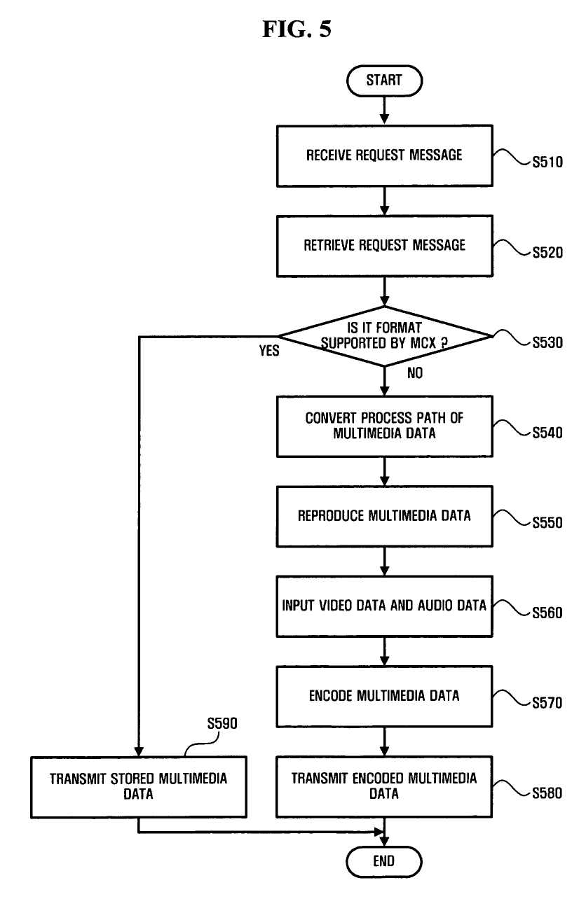

FIG. 5 is a flowchart illustrating a process to output multimedia data according to an embodiment of the present invention.

In order to output the multimedia data, the communication unit 370 of the multimedia data output apparatus 230 receives the request message 225 for multimedia data transmitted by the MCX 220 (S510). The request message 225 may, although not necessarily, include a file name and a storage path of the multimedia data.

The request message 225 is transmitted to the retrieving unit 340, and the retrieving unit 340 retrieves the multimedia data described in the request message from the storing unit 360 (S520). That is, the retrieving unit 340 retrieves the multimedia data by, for example, using the file name and the storing path of the multimedia data contained in the request message, and the retrieved result is transmitted to the control unit 330. In this case, a header or metadata of the multimedia data may, although not necessarily, be contained in the retrieved result.

The control unit 330 determines whether the multimedia data is of the format supported by the MCX 220 by referring to the transmitted retrieved result (S530). As a result, if the retrieved multimedia data is of the format supported by the MCX 220, the control unit 330 transmits a transmission instruction of the corresponding multimedia data to the communication unit 370.

Then, the communication unit 370 transmits the multimedia data stored in the storing unit 360 to the MCX 220 by using a predetermined communication method (S590). Wire communication methods such as, although not limited to, Ethernet, Universal Serial Bus (USB), IEEE 1394, serial communication, and parallel communication may, although not necessarily, be used to communicate between the communication unit 370 and the MCX 220. In addition, wireless communication methods such as, although not limited to, Infrared Data Association, Bluetooth, home RF, and a wireless LAN may, although not necessarily, be used.

The multimedia data process path determined by the control unit 330 may be determined according to the user's instruction. The multimedia data process path may be determined by only the output unit 310 or the encoding unit 350, and the multimedia data process path may be determined such that the multimedia data can be transmitted to the output unit 310 and the encoding unit 350.

If the retrieved multimedia data has a data format not supported by the MCX 220, the control unit 330 converts the multimedia data process path (S540). That is, the switches included in the video processing unit 321 and the audio processing unit 322 are controlled such that the video data and the audio data inputted to the video processing unit 321 and the audio processing unit 322 are outputted to the encoding unit 350.

In addition, the retrieved multimedia data is reproduced by a predetermined reproducing program (S550), and the reproduced video data and the audio data are inputted to the video processing unit 321 and the audio processing unit 322 (S560).

The video data and the audio data that are inputted to the video processing unit 321 and the audio processing unit 322 are outputted through the TV out port 410 and the line out port 420 according to the multimedia data process path determined by the control unit 330, and then transmitted to the TV in port 430 and the line in port 440 of the encoding unit 350.

In addition, the encoding unit 350 encodes the transmitted video data and audio data to multimedia data of the format supported by the MCX 220 (S570). That is, the encoding unit 350 encodes the transmitted video data and audio data into data of an MPEG or a WMV format.

The encoded multimedia data may, although not necessarily, be stored in the storing unit 360, and the communication unit 370 transmits the multimedia data stored in the format supported by the MCX 220 to the MCX 220 (S580).

The apparatus to output multimedia data converts multimedia data of all applicable formats into multimedia data formats supported by the media center extender and outputs the converted multimedia data. Therefore, multimedia data of formats not supported by the media center extender can also be displayed through a TV screen. However, it is understood that the media center extender does not necessarily transmit the multimedia data to be displayed by a TV. The media center extender may transmit the multimedia data to be displayed by any moving picture projection device.

Multimedia data of all of formats supported by the computer is displayed without changing the system structure of the media center extender, which results in reducing the cost required when a new system is constructed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to output multimedia data, the apparatus comprising:
a data processing unit to receive video data and audio data;
a control unit to control a process path of the received video data and the received audio data according to whether the received video data and the received audio data are of a predetermined compression format;
an encoding unit to encode the received video data and the received audio data transmitted according to the process path into the predetermined compression format if the received video data and the received audio data are not of the predetermined compression format; and
a communication unit to transmit multimedia data to be displayed on one or more audio and/or video projection devices, wherein at least one of the one or more audio and/or video projection devices is external to the apparatus.

2. The apparatus as claimed in claim 1, further comprising a storing unit to store the audio data and the video data, wherein the audio data and the video data received by the data processing unit are stored in the storing unit and reproduced by a predetermined reproducing program.

3. The apparatus as claimed in claim 1, further comprising a TV receiving unit to receive television signals comprising the video data and the audio data, wherein the video data and audio data received by the data processing unit are inputted from the TV receiving unit.

4. The apparatus as claimed in claim 1, wherein the data processing unit comprises a video processing unit to receive the video data, and an audio processing unit to receive the audio data.

5. The apparatus as claimed in claim 4, wherein the control unit controls the process path by using switches provided in the video processing unit, the audio processing unit, and the encoding unit, wherein the control unit determines whether the video data and the audio data are of the predetermined compression format.

6. The apparatus as claimed in claim 5, wherein the control unit controls the process path to lead the video data and the audio data from the data processing unit to the encoding unit when the video data and the audio data are not of the predetermined compression format.

7. The apparatus as claimed in claim 5, wherein the control unit control the process path to lead the video data and the audio data from the data processing unit to the communication unit when the video data and the audio data are of the predetermined compression format.

8. The apparatus as claimed in claim 1, wherein the predetermined compression format comprises a Motion Picture Experts Group (MPEG) format or a Windows Media Video (WMV) format.

9. The apparatus as claimed in claim 1, wherein the communication unit outputs the multimedia data through a wire communication method or a wireless communication method.

10. The apparatus as claimed in claim 1, further comprising an output unit to display the video data and output the audio data, wherein the control unit controls the process path to lead the video data and the audio data from the data processing unit to the output unit when the video data and the audio data are of the predetermined compression format.

11. The apparatus as claimed in claim 10, wherein the output unit comprises a display unit to display the video data.

12. The apparatus as claimed in claim 10, wherein the output unit comprises an audio output unit to output the audio data.

13. The apparatus as claimed in claim 2, wherein the storing unit stores the encoded video data and the encoded audio data.

14. The apparatus as claimed in claim 2, further comprising a retrieving unit to retrieve, from the storing unit, the video data and the audio data to be transmitted, wherein the retrieving unit receives a request message inputted to the apparatus from a user, wherein the request message comprises a file name and/or a storage path of the video data and the audio data to be transmitted.

15. The apparatus as claimed in claim 14, wherein the retrieved data comprises a header and/or metadata.

16. The apparatus as claimed in claim 1, wherein the communication unit transmits the multimedia data to a media center extender, and at least one of the one or more audio and/or video projection devices is a television.

17. A method of outputting multimedia data from an apparatus to output multimedia data, the method comprising:
receiving video data and audio data;
controlling a process path of the received video data and the received audio data according to whether the received video data and the received audio data are of a predetermined compression format;
encoding the received video data and the received audio data, transmitted according to the controlled process path, into the predetermined compression format when the received video data and the received audio data are not of the predetermined compression format; and
transmitting the video data and the audio data in the predetermined compression format to be displayed on one or more audio and/or video projection devices, wherein at least one of the one or more audio and/or video projection devices is external to the apparatus to output multimedia data.

18. The method as claimed in claim 17, further comprising storing the audio data and the video data, wherein the receiving of the audio data and the video data comprises reproducing the stored audio data and the stored video data by a predetermined reproducing program.

19. The method as claimed in claim 17, further comprising receiving television signals comprising the audio data and the video data.

20. The method as claimed in claim 17, further comprising determining whether the audio data and the video data are of the predetermined compression format.

21. The method as claimed in claim 17, wherein the predetermined compression format comprises an MPEG format or a WMV format.

22. The method as claimed in claim 17, wherein the transmitting of the multimedia data comprises outputting the video data and the audio data in the predetermined compression format by using a wire or wireless communication method.

23. The method as claimed in claim 17, further comprising storing the encoded video data and the encoded audio data.

24. The method as claimed in claim 18, further comprising retrieving the stored video data and the stored audio data to be transmitted, wherein the retrieving of the stored video data and the stored audio data to be transmitted comprises receiving, from a user, a request message comprising a file name and/or a storage path of the stored video data and the stored audio data to be transmitted.

25. A multimedia data output apparatus to transmit multimedia data supported by a media center extender (MCX) to the MCX connected to at least one television, the apparatus comprising:
a data processing unit to receive video data and audio data;
a control unit to control a process path of the received video data and the received audio data according to whether the received video data and the received audio data are of a predetermined compression format supported by the MCX;
an encoding unit to encode the video data and the audio data transmitted according to the process path into the predetermined compression format supported by the MCX; and
a communication unit to transmit the video data and the audio data of the predetermined compression format to the MCX to be displayed on the at least one television, and to receive from the MCX a request message to transmit the video data and the audio data.
